(19) United States
(12) Patent Application Publication
(10) Pub. No.: US 2002/0182367 A1
(43) Pub. Date: Dec. 5, 2002

(54) Reinforced plastic film

(76) Inventors: Edward R. Salzsauler, Georgetown (CA); Richard G. Salzsauler, Rockwood (CA); Donald J. Salzsauler, Georgetown (CA)

Correspondence Address: GOWLING LAFLEUR HENDERSON LLP, P.O. Box 1045 LCD1, Suite 560, 120 King Street West, Hamilton, ON, L8M, CA

(21) Appl. No.: 10/153,599

(22) Filed: May 24, 2002

Related U.S. Application Data
(60) Provisional application No. 60/293,553, filed on May 29, 2001.

(51) Int. Cl. B32B 3/14

(52) U.S. Cl. 428/77

(57) ABSTRACT

Reinforced plastic film comprising a length of plastic film and a reinforcing strip of plastic film integral therewith and extending along the length of the film and spaced from its opposite side edges.

### RELATED APPLICATION

This application claims priority from U.S. Provisional Patent Application No. 60/293,553 filed May 29, 2001.

### FIELD OF INVENTION

This invention relates to reinforced plastic film which is useful (inter alia) for wrapping pelletised loads.

### BACKGROUND OF THE INVENTION

It is known to use reinforced plastic film for wrapping pelletised loads, see for example U.S. Pat. No. 5,531,391 (Salzsauler et al) issued Jul. 2, 1996, the contents of which are hereby incorporated herein by reference, which describes plastic film with the two opposite outermost side edges being thicker than the remainder of the film for strengthening the outermost edges of the film. Although such plastic film is satisfactory for various pelletised loads, there still exists a need for improved plastic film.

### SUMMARY OF INVENTION

According to the present invention, elongated plastic film is provided with at least one reinforcing strip of plastic film integral therewith and extending along the length of the film and spaced from its opposite side edges. The or each reinforcing strip may be incorporated in the film during manufacture thereof or may be applied thereto after manufacture.

A particular advantage of the invention is that, if the film is punctured during use, a resultant tear will be stopped from excessive lateral travel by any reinforcing strip which it encounters.

The plastic film may for example have a thickness in the range of from about 10 to about 100 microns, and each reinforcing strip may have a thickness in the range of from about 10 to about 100 microns. Each reinforcing strip may have a width in the range of from about 0.25 to about 2.5 inches.

The plastic film and each reinforcing strip may be single or multilayer stretch plastic film of any suitable material and may be of the same or different material. Typically, for pelletising loads, the plastic film may be single layer linear low density polyethylene.

### DESCRIPTION OF THE DRAWINGS

Embodiments of the present invention will now be described, by way of example, with reference to the accompanying drawings, which:

FIG. 1 is a perspective view of a roll of reinforced plastic film in accordance with one embodiment of the invention,

FIG. 2 is a similar view to FIG. 1 but showing an initial portion of the film unwound from the roll,

FIG. 2A is a sectional view of the film taken along the line 2A-2A of FIG. 2,

FIG. 3 is a diagrammatic view showing one method of making a reinforced plastic film in accordance with the invention, and

FIG. 4 is a similar view to FIG. 3 but showing another method for making a reinforced plastic film in accordance with the invention.

### DESCRIPTION OF PREFERRED EMBODIMENTS

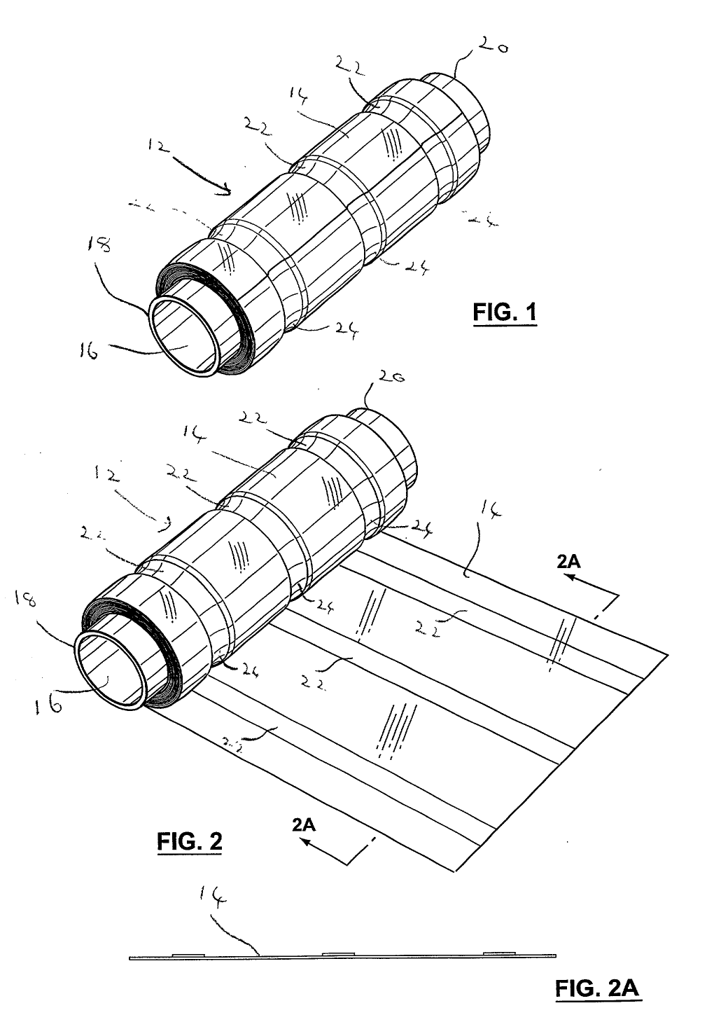

Referring first to FIGS. 1 to 2 of the drawings, a roll 12 of reinforced plastic film comprises a length of plastic film 14 wound on a cylindrical core 16 which is conventionally made of laminated paperboard. It will be noted that opposite end portions 18, 20 of the core 16 project a short distance beyond the edges of the plastic film 14. In this embodiment of the invention, the plastic film 14 has three laterally spaced longitudinally extending integral reinforcing strips 22 spaced from the opposite side edges of the film 14. In this embodiment, the reinforcing strips 22 are of the same plastic material and the same thickness as the plastic film 14.

When the reinforced plastic film 14 is wound on the core 16, the reinforcing strips 22 become wound at a slightly lesser diameter than the film 14, with the result that the reinforcing strips 22 form annular constrictions 24 around the roll 12.

The reinforced plastic film 14 is especially suitable for wrapping around pelletised loads, and the projecting end portions 18, 20 at the core 16 provide convenient handles for manually holding the roll while the film 14 is being wrapped around a load.

It will readily be appreciated by a person skilled in the art that the integral reinforcing strips 22 not only reinforce the film 14 but also provide stops for any tears which may occur in the film when in use.

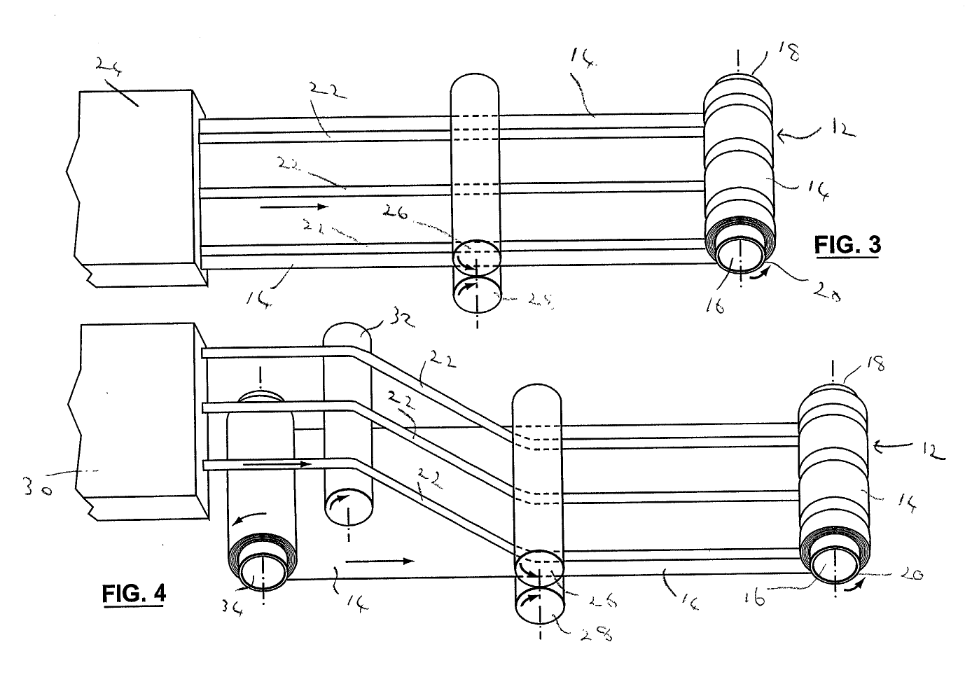

The film 14 may be provided with reinforcing strips 22 during manufacture or after manufacture in a separate operation. FIG. 3 shows the film 14 and integral reinforcing strips 22 being extruded from a flat die 24 and passing between rollers 26,28 before being wound on the core 16. FIG. 4 shows the reinforcing strips 22 being extruded from a die 30 and passing over a guide roller 32 before passing between rollers 26, 28 where they are mated by heat and pressure with a pre-manufactured film 14 being unwound from a roll 34 before winding onto core 16.

If desired, the core 16 may be omitted so that the roll 12 is coreless, for example as described in U.S. Pat. No. 6,102,213 (Salzsauler et al) issued Aug. 15, 2000, the contents of which are also hereby incorporated herein by reference.

Other embodiments of the invention will now be readily apparent to a person skilled in the art, the scope of the invention being defined in the appended claims.

1. Reinforced plastic film comprising a length of plastic film and a reinforcing strip of plastic film integral therewith and extending along the length of the film and spaced from its opposite side edges.

2. Reinforced plastic film according to claim 1 when the reinforcing strip was incorporated in the length of plastic film during manufacture thereof.

3. Reinforced plastic film according to claim 1 wherein the reinforcing strip was supplied to the length of plastic film after manufacture thereof.

4. Reinforced plastic film according to claim 1 wherein the length of plastic film has a thickness in the range of from about 10 to about 100 microns.

5. Reinforced plastic film according to claim 1 wherein each reinforcing strip has a thickness in the range of from about 10 to about 100 microns.

6. Reinforced plastic film according to claim 1 wherein each reinforcing strip has a width in the range from about 0.25 to about 2.5 inches.

7. Reinforced plastic film according to claim 1 wherein the length of plastic film has a thickness in the range of from about 10 to about 100 microns, and each reinforcing strip has a thickness in the range of from about 10 to about 100 microns and a width in the range of from about 0.25 to about 2.5 inches.
